(19) United States
(12) Patent Application Publication
(10) Pub. No.: US 2012/0315512 A1
(43) Pub. Date: Dec. 13, 2012

(54) POSITIVE ELECTRODE FOR LITHIUM ION BATTERY

(75) Inventors: Kan KITAGAWA, Hitachinaka (JP); Hiroshi IWASAWA, Hitachi (JP); Shin YAMAUCHI, Mito (JP); Shin TAKAHASHI, Mito (JP)

(73) Assignee: HITACHI, LTD., Tokyo (JP)

(21) Appl. No.: 13/492,257

(22) Filed: Jun. 8, 2012

(30) Foreign Application Priority Data
Jun. 10, 2011 (JP) 2011-129661

(51) Int. Cl. H01M 4/485; H01M 4/525; H01M 4/583; H01M 4/505

(52) U.S. Cl. 429/50; 429/231.95; 429/224; 429/221; 429/231.3; 429/223; 429/231.8; 429/231.1; 252/182.1

(57) ABSTRACT

A positive-electrode material for a lithium ion battery includes two or more types of positive-electrode active materials which are expressed by a chemical formula LiMPO4 (where M includes one or more types of metal elements selected from the group consisting of Mn, Fe, Co, and Ni) and which have an olivine structure. The M in at least one of the positive-electrode active materials includes two or more types of metal elements. An open circuit voltage curve in charging includes an initial rising region, one or more flat regions, one or more detectable voltage varying regions, and a terminal rising region in a state-of-charge region of 0% to 100%.

### BACKGROUND OF THE INVENTION

1. Field of the Invention

The present invention relates to a positive electrode for a lithium ion battery.

2. Background Art

In the past, lithium cobalt oxide was mainly used as a positive-electrode active material for a lithium ion battery. Lithium ion batteries using such a positive-electrode active material have been widely used.

However, cobalt as a source material of lithium cobalt oxide has a small amount of production and is high in cost, and thus an alternative material has been studied. Lithium manganate having a spinel structure which is an example of an alternative material does not have a sufficient discharge capacity and has a problem in that manganese is eluted at high temperatures. Lithium nickel oxide which is expected for a large capacity has a problem in thermal stability at high temperatures.

For this reason, an olivine positive-electrode active material (hereinafter, also referred to as “olivine”) having high thermal stability and superior safety has been expected as a positive-electrode active material. This positive-electrode active material has a strong P—O bond in the crystal structure thereof and thus oxygen is not detached therefrom at high temperatures.

Layered positive-electrode active materials such as lithium cobalt oxide having been used from the past vary in potential depending on the state of charge (hereinafter, abbreviated to SOC). Accordingly, the output of a battery varies depending on the SOC of the battery. Regarding the SOC, the fully-discharged state is defined as 0% and the fully-charged state is defined as 100%.

On the contrary, it is known that olivine causes a two-phase coexistent reaction of a lithium-containing phase (LiMPO₄) and a non-lithium-containing phase (MPO₄). Accordingly, the reaction potential curve of olivine has plural flat parts with respect to the SOC, where the flat part means a region in which a voltage slightly varies or does not vary at all with the variation in SOC. Accordingly, a battery using olivine can provide a stable output.

JP-A-2010-27409 discloses a lithium ion battery including two or more types of positive-electrode active materials having different lithium ion diffusion coefficients as a positive-electrode active material, which includes a compound expressed by the same compositional formula and performs two-phase-coexistence charging and discharging.

Journal of Power Sources 189 (2009), 397-401, and J. Phys. Chem. C114 (2010), 15530-15540, disclose that the value of a flat part (hereinafter, also referred to as a “flat potential part”) of a potential curve with respect to a depth of charge of olivine varies depending on the central metal M, that the value of the flat potential part is about 3.45 V in LiFePO₄, about 4.1 V in LiMnPO₄, and about 4.8 V in LiCoPO₄, that the flat part is divided depending on the composition ratio of metal elements when the central metal M includes plural elements (for example, the flat part of 4.1 V based on Mn in LiMn_{0.5}Fe_{0.5}PO₄ and the flat part around 3.45 V based on Fe is 50%), that the potential of the flat part varies slightly in comparison with a non-mixed case and is shifted toward the potential of a mixing partner, and that the shift magnitude of the potential increases as the composition ratio of the mixing partner increases.

### SUMMARY OF THE INVENTION

As described above, in a battery using a layered compound such as lithium cobalt oxide, the SOC of the battery can be detected from a voltage by the use of the variation in potential of a positive electrode based on the SOC. On the other hand, since olivine has superior characteristics but has the flat potential part, it is difficult to detect the SOC. That is, since olivine has plural regions in which the correlation between the SOC and the potential is very small, it is difficult to use the information of the positive electrode to detect the SOC from the voltage of the battery.

Accordingly, in the case of a battery using olivine, overcharging or over-discharging is caused which shortens the lifetime or rapidly lowers the output power, thereby deactivating a battery system.

An object of the invention is to provide a lithium ion battery which can prevent overcharging and over-discharging by enabling the detection of the SOC, which can stabilize the output, and which can guarantee high safety.

According to an aspect of the invention, there is provided a positive-electrode material for a lithium ion battery including two or more types of positive-electrode active materials which are expressed by a chemical formula LiMPO₄ (where M includes one or more types of metal elements selected from the group consisting of Mn, Fe, Co, and Ni) and which have an olivine structure, wherein the M in at least one of the positive-electrode active materials includes two or more types of metal elements, and an open circuit voltage curve in charging includes an initial rising region, one or more flat regions, one or more detectable voltage varying regions, and a terminal rising region in a state-of-charge region of 0% to 100%.

According to the aspect of the invention, it is possible to provide a lithium ion battery which can prevent overcharging and over-discharging by enabling the detection of the SOC, which can stabilize the output, and which can guarantee high safety.

### BRIEF DESCRIPTION OF THE DRAWINGS

FIG. 1 is a partial sectional view illustrating the constitution of a cylindrical lithium ion battery.

FIG. 2A is a diagram illustrating an open circuit voltage curve of a lithium ion battery using a positive electrode including a positive-electrode material for a lithium ion battery according to Example 1.

FIG. 2B is a diagram illustrating a dV/dQ curve of the lithium ion battery using the positive electrode including the positive-electrode material for a lithium ion battery according to Example 1.

FIG. 3A is a diagram illustrating an open circuit voltage curve of a lithium ion battery using a positive electrode including a positive-electrode material for a lithium ion battery according to Comparative Example 1.

FIG. 3B is a diagram illustrating a dV/dQ curve of the lithium ion battery using the positive electrode including the positive-electrode material for a lithium ion battery according to Comparative Example 1.

FIG. 4A is a diagram illustrating an open circuit voltage curve of a lithium ion battery using a positive electrode including a positive-electrode material for a lithium ion battery according to Example 2.

FIG. 4B is a diagram illustrating a dV/dQ curve of the lithium ion battery using the positive electrode including the positive-electrode material for a lithium ion battery according to Example 2.

FIG. 5A is a diagram illustrating an open circuit voltage curve of a lithium ion battery using a positive electrode including a positive-electrode material for a lithium ion battery according to Comparative Example 2.

FIG. 5B is a diagram illustrating a dV/dQ curve of the lithium ion battery using the positive electrode including the positive-electrode material for a lithium ion battery according to Comparative Example 2.

FIG. 6A is a diagram illustrating an open circuit voltage curve of a lithium ion battery using a positive electrode including a positive-electrode material for a lithium ion battery according to Example 3.

FIG. 6B is a diagram illustrating a dV/dQ curve of the lithium ion battery using the positive electrode including the positive-electrode material for a lithium ion battery according to Example 3.

FIG. 7A is a diagram illustrating an open circuit voltage curve of a lithium ion battery using a positive electrode including a positive-electrode material for a lithium ion battery according to Comparative Example 3.

FIG. 7B is a diagram illustrating a dV/dQ curve of the lithium ion battery using the positive electrode including the positive-electrode material for a lithium ion battery according to Comparative Example 3.

FIG. 8A is a diagram illustrating an open circuit voltage curve of a lithium ion battery using a positive electrode including a positive-electrode material for a lithium ion battery according to Example 4.

FIG. 8B is a diagram illustrating a dV/dQ curve of the lithium ion battery using the positive electrode including the positive-electrode material for a lithium ion battery according to Example 4.

FIG. 9A is a diagram illustrating an open circuit voltage curve of a lithium ion battery using a positive electrode including a positive-electrode material for a lithium ion battery according to Comparative Example 4.

FIG. 9B is a diagram illustrating a dV/dQ curve of the lithium ion battery using the positive electrode including the positive-electrode material for a lithium ion battery according to Comparative Example 4.

### DETAILED DESCRIPTION OF THE INVENTION

The invention relates to a positive-electrode material for a lithium ion battery, and a positive electrode and a battery using the positive-electrode material.

Hereinafter, a positive-electrode material for a lithium ion battery, a lithium ion battery using the positive-electrode material, and a method of controlling the lithium ion battery according to an embodiment of the invention will be described.

The positive-electrode material for a lithium ion battery includes two or more types of positive-electrode active materials which are expressed by a chemical formula LiMPO₄ (where M includes one or more types of metal elements selected from the group consisting of Mn, Fe, Co, and Ni) and which have an olivine structure, wherein the M in at least one of the positive-electrode active materials includes two or more types of metal elements and the at least one of the positive-electrode active materials has Structures 1 or 2, and an open circuit voltage curve (hereinafter, also referred to as an “OCV curve”) in charging includes an initial rising region, one or more flat regions, one or more detectable voltage varying regions, and a terminal rising region in a state-of-charge region of 0% to 100%.

Structure 1: Two types of the positive-electrode active material include a common metal element which is common to the positive-electrode active materials as any of the metal elements and have a difference in the ratio of the common metal element in the M.

Structure 2: At least one type of the positive-electrode active materials is a cobalt-containing positive-electrode active material including Mn and Co as the M and at least one type of the positive-electrode active materials is an iron-containing positive-electrode active material including Mn and Fe as the M.

In the positive-electrode material for a lithium ion battery, it is preferable that the difference in the ratio be equal to or more than 0.3.

In the positive-electrode material for a lithium ion battery, it is preferable that the ratio of Co in the Min the cobalt-containing positive-electrode active material be in the range of 0.05 to 0.3 and the ratio of Co in the M in the overall positive-electrode active materials expressed by the chemical formula be equal to or less than 0.1.

In the positive-electrode material for a lithium ion battery, it is preferable that the voltage varying region be a region in which the potential varies by 20 mV or more and up to 200 mV when the state of charge varies by 3%.

The lithium ion battery includes a positive electrode, a negative electrode, and a separator interposed between the positive electrode and the negative electrode. The positive electrode includes the positive-electrode material for a lithium ion battery.

In the lithium ion battery, it is preferable that the negative electrode include a negative-electrode active material which is activated in a two-phase-coexistence charging-discharge reaction.

In the lithium ion battery, it is preferable that the negative-electrode active material be graphite or lithium titanate.

The method of controlling a lithium ion battery includes connecting a current measuring circuit and a voltage measuring circuit to the lithium ion battery, calculating a derivative of a potential with respect to an amount of electrical storage of the lithium ion battery from the variations in current and voltage when the battery operates, and detecting the state of charge from the derivative.

The potential in the flat region of the OCV curve of olivine varies depending on the central metal M and is about 3.45 V in LiFePO₄, about 4.1 V in LiMnPO₄, and about 4.8 V in LiCoPO₄. When the central metal M includes plural elements, the flat region is divided depending on the composition ratio of metal elements. For example, in LiMn_{0.5}Fe_{0.5}PO₄, the flat region of 4.1 V based on Mn is 50% and the flat region around 3.45 V based on Fe is 50%. The potential in the flat region varies slightly in comparison with the case where the central metal M includes only one type of element, and shifts toward the potential of another element constituting the central metal M. As the composition ratio of another element increases, the shift width of the potential increases (see Journal of Power Sources 189 (2009), 397-401, and J. Phys. Chem. C114 (2010), 15530-15540).

By using the characteristics of olivine, a level difference in potential (hereinafter, also referred to as a “potential level difference”) can be provided to the flat region and it is thus possible to detect the SOC.

In the case of a positive electrode formed of two or more sets of olivine of which M includes two or more types of metals and which have different metal composition ratios in the M, the OCV curve has a large potential level difference and a small potential level difference. The large potential level difference is a level difference when the types of M participating in the reaction vary in charging and discharging. That is, the large potential level difference is a potential variation when metal elements such as Fe, Mn, and Co participating in the reaction vary. This potential level difference occurs when plural metal elements are included. Accordingly, the potential level difference can occur even when olivines having different compositions are not mixed, that is, when olivine having a single composition is used.

On the contrary, the small potential level difference is a level difference based on the same metal element. In olivines having different compositions, since the shift width of potential differs even at the reaction potential of the same metal element, a potential level difference occurs. For example, when LiMn_{0.8}Fe_{0.2}PO₄ and LiMn_{0.5}Fe_{0.5}PO₄ including Mn and Fe are mixed together at 50:50 (Mn is 65% and Fe 35% overall), the large potential level difference is a variation between about 3.45 V at which Fe reacts and about 4.1 V at which Mn reacts, and the large potential level difference occurs at a SOC of 35%.

The small potential level difference occurs at a region of 3.45 V (Fe) and a region of 4.1 V (Mn). Since LiMn_{0.8}Fe_{0.2}PO₄ is mixed with more Mn than LiMn_{0.5}Fe_{0.5}PO₄, the potential shift (potential rising) of Fe is greater.

Therefore, the potential in Fe (10% overall) based on LiMn_{0.8}Fe_{0.2}PO₄ and the potential in Fe (25% overall) based on LiMn_{0.5}Fe_{0.5}PO₄ are different from each other in the flat region around 3.45 V and the boundary potential level difference occurs at the SOC of 25%.

Similarly, the potential shift (potential drop) of Mn is greater in LiMn_{0.5}Fe_{0.5}PO₄ which is mixed with more Fe. Accordingly, the potential in Mn (40% overall) based on LiMn_{0.8}Fe_{0.2}PO₄ and the potential in Mn (25% overall) based on LiMn_{0.5}Fe_{0.5}PO₄ are different from each other and the boundary potential level difference occurs at the SOC of 60%. This small potential level difference is caused by a shift amount based on the composition difference, and thus occurs only when olivines having different compositions are mixed together.

By mixing two or more types of olivines having different composition ratios, it is possible to increase the number of potential level differences. In the above-mentioned case where LiMn_{0.8}Fe_{0.2}PO₄ and LiMn_{0.5}Fe_{0.5}PO₄ are mixed at 50:50, two more potential level differences are included than when LiMn_{0.65}Fe_{0.35}PO₄ having the same Mn/Fe ratio is simply used, thereby facilitating detection of the state of charge. For the olivines that are mixed together, none may include two or more types of metal elements and one or more may include two types of metals. However, olivines need to have a difference in composition sufficient to cause the potential based on the included same type of metal element to shift and to cause a level difference.

Since the potential level difference occurring in this way appears at the determined SOC, the potential level difference can be detected from the variation in dV/dQ (wherein Q represents an amount of electrical storage), thereby accurately determining the state of charge at that time. By measuring an open circuit voltage (OCV) of a battery and combining the values of a potential curve prepared in advance therewith, it is possible to determine the SOC within a specific level difference range. Here, the open circuit voltage (OCV) means a voltage across both terminals of a battery when a load is not applied to the battery. That is, the OCV is a voltage across both terminals of a battery when the battery is not connected to any device (in a state where current does not flow).

When an active material working in a two-phase-coexistence charging-discharging reaction is used as a negative-electrode active material in the lithium ion battery, the features of the positive electrode are more useful. That is, when the negative electrode is a two-phase coexistence type, the voltage variation with the variation in SOC is not sufficient, and the olivine is used for the positive electrode, neither of both electrodes provides information on the SOC. In this case, the control is more difficult. At this time, when the olivine positive electrode with which level differences can occur at determined SOCs can be used, it is possible to acquire information on the SOC. Examples of the two-phase-coexistence negative-electrode active material include graphite or lithium titanate.

In order to detect the level difference, it is preferable that the variation in voltage in the level difference be 20 mV or more to 200 mV. The large potential level difference is necessarily equal to or greater than 20 mV. However, the small potential level difference is less than 20 mV with some differences in shift. In this case, it is difficult to detect the SOC. When the composition ratio of the same metal varies by 0.3 or more in two active materials, a satisfactory potential level difference is acquired. In the case of the olivines having two or more compositions having different types of metal constituting the M, the shift direction may be reversed. In this case, since a large potential level difference is obtained, it is not necessary to provide a large difference to the composition ratio.

For example, when Mn is substituted with Fe and Co, the potential of Mn is lowered by the substitution with Fe and the potential of Mn is raised by the substitution with Co. Accordingly, a large potential level difference is easily formed. However, when Co in the olivine in an organic electrolyte used currently mainly is charged and discharged, the potential of 4.6 V or more is necessary. When the battery operates at this potential, the lifetime of the battery is adversely affected, which is not preferable. When the potential is suppressed and Co is not charged nor discharged, the energy density is lowered with the increase in the ratio of Co. Accordingly, the Co composition in the olivine including Co is preferably in the range of 0.05 to 0.3. When the Co composition is equal to or more than 0.05, a satisfactory potential shift is achieved. When the Co composition is greater than 0.3, the decrease in capacity is greatly influenced. The composition ratio of Co with respect to the whole positive electrode is preferably equal to or less than 0.1.

In this way, by mixing the positive-electrode active materials having plural compositions, it is possible to provide the potential level differences to the open circuit voltage curve (OCV curve). The positions of the SOC where the potential level differences appear can be set with a certain degree of freedom by changing the composition or mixing ratio.

The positive electrode for a lithium ion battery and the lithium ion battery according to the invention will be described below.

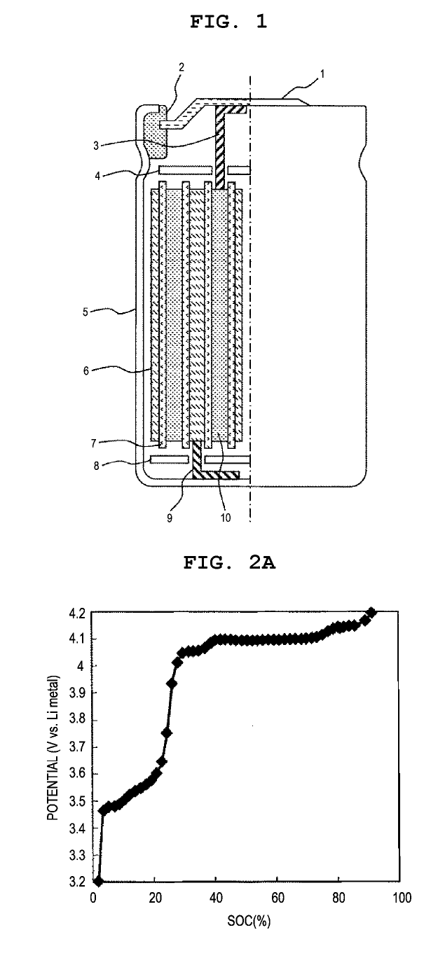

FIG. 1 shows an example of a lithium ion battery employing the positive electrode for a lithium ion battery according to the invention.

In this drawing, a cylindrical lithium ion battery is exemplified.

The lithium ion battery shown in the drawing includes a positive electrode 10 (the positive electrode for a lithium ion battery according to the invention), a negative electrode 6, a separator 7, a positive electrode lead 3, a negative electrode lead 9, a battery cover 1, a gasket 2, an insulating plate 4, an insulating plate 8, and a battery can 5. The positive electrode 10 and the negative electrode 6 are wound with a separator 7 interposed therebetween, and an electrolyte solution in which an electrolyte is dissolved in a solvent is impregnated in the separator 7.

The positive electrode 10, the negative electrode 6, and the separator 7 will be described below in detail.

### (1) Positive Electrode

The positive electrode for a lithium ion battery includes a positive-electrode active material, a binder, and a collector and the surface of the collector is coated with a positive-electrode composite material including the positive-electrode active material and the binder. In order to compensate for electron conductivity, a conducting agent may be added to the positive-electrode composite material if necessary.

In this specification, the positive-electrode material includes one or more types of positive-electrode active materials and further includes a conducting agent if necessary.

The positive-electrode active material, the binder, the conducting agent, and the collector constituting the positive electrode for a lithium ion battery will be described below in details.

### A) Positive-Electrode Active Material

An active material having an olivine structure having the above-mentioned features is used as the positive-electrode active material. The olivine can be synthesized through the use of a known synthesis method. Examples of the synthesis method include a solid-phase method, a hydrothermal synthesis method, and a citric acid method. The synthesis method is not particularly limited, as long as an olivine phase is generated and metal elements are uniformly mixed. In order to compensate for the low conductivity of the olivine, it is preferable that the surface thereof be coated with a conductive material such as carbon.

### B) Binder

General binders such as PVDF (Polyvinylidene fluoride) and polyacrylonitrile can be suitably used as the binder. The binder is not particularly limited, as long as it has a sufficient binding property.

### C) Conducting Agent

In the positive electrode, by using the binder having superior close adhesiveness and mixing a conducting agent therewith to provide conductivity, a strong conductive network is formed. Accordingly, the conductivity of the positive electrode is improved and the capacity or rate characteristics are improved, which is preferable. The conducting agent used for the positive electrode according to the invention and the amount thereof added will be described below.

A carbon-based conducting agent such as acetylene black and graphite powder can be used as the conducting agent. Since the olivine-manganese-based positive-electrode active material has a relatively large specific surface area, the specific surface area of the conducting agent is preferably large to form the conductive network and preferable examples thereof include acetylene black. The positive-electrode active material may be coated with carbon. In this case, the carbon used to coat the positive-electrode active material may be made to have the function of a conducting agent.

### D) Collector

A support (metal foil) such as an aluminum foil having conductivity can be used as the collector.

### (2) Negative Electrode

The negative electrode for a lithium ion battery includes a negative-electrode active material, a conducting agent, a binder, and a collector.

The negative-electrode active material is not particularly limited, as long as Li can be reversibly inserted into or removed from it through charging and discharging. Examples thereof include a carbon material, metal oxide, metal sulfide, lithium metal, and alloy negative electrode employing an element which forms an alloy along with lithium. Graphite, amorphous carbon, coke, pyrolytic carbon, and the like can be used as the carbon material.

Known materials can be used as the conducting agent, and a carbon-based conducting agent such as acetylene black and graphite powder can be used. Similarly, known materials can be used as the binder, and PVDF (Polyvinylidene Fluoride), SBR (Styrene-Butadiene Rubber), NBR (nitrile-butadiene rubber), and the like can be used as the binder. Known materials can be used as the collector, and a support (metal foil) such as a copper foil having conductivity can be used as the collector.

### (3) Separator

Known materials can be used for the separator and the material thereof is not particularly limited. A polyolefin-based porous film of polypropylene, polyethylene, or the like or a glass fiber sheet can be used for the separator.

### (4) Electrolyte

Lithium salts such as LiPF₆, LiBF₄, LiCF₃SO₃, LiN(SO₂CF₃)₂/and LiN (SO₂F)₂ can be used singly or in combination as the electrolyte. Chained carbonate, annular carbonate, annular ester, nitrile compounds and the like can be used as the solvent used to dissolve the lithium salts. Specific examples thereof include ethylene carbonate, propylene carbonate, diethyl carbonate, dimethoxyethane, γ-butyrolactone, n-methylpyrrolidine, and acetonitrile.

In addition, a polymer-gel electrolyte or a solid electrolyte can be used as the electrolyte.

Various shapes of lithium ion batteries such as a cylindrical battery, an angular battery, and a laminated battery can be constructed by the use of the positive electrode, the negative electrode, the separator and the electrolyte.

The invention will be described below with reference to examples. The invention is not limited to the examples, without departing from the concept of the invention.

### Example 1

### Synthesis of Positive-electrode Active Material

Iron oxalate and manganese oxalate were weighed as metal sources so that the mole ratio of Fe and Mn is 2:8. Lithium dihydrogen phosphate was added thereto by a mole equal to the total mole of metal elements (Fe and Mn). 10 wt % of sucrose was added thereto and the resultant was pulverized and mixed in a ball mill. The mixture was baked in the atmosphere of argon (Ar atmosphere) at a high temperature of 700° C. for 10 hours, whereby LiMn_{0.8}Fe_{0.2}PO₄ coated with carbon was obtained.

LiMn_{0.5}Fe_{0.5}PO₄ and LiMn_{0.8}Co_{0.2}PO₄ were synthesized through the use of the same method. Cobalt oxalate was used as a Co source.

A positive electrode was manufactured in the following order.

LiMn_{0.8}Fe_{0.2}PO₄, LiMn_{0.5}Fe_{0.5}PO₄, and LiMn_{0.8}Co_{0.2}PO₄ were weighed and mixed so that the weight ratio thereof was 60:25:15. 7.5 parts by weight of acetylene black and 7.5 parts by weight of polyacrylonitrile were weighed and mixed to 85 parts by weight of the mixed positive-electrode active material. The NMP was added thereto to produce a positive-electrode slurry. The surface of an aluminum collector foil (AL collector foil) was coated with the positive-electrode slurry by an amount of 5 to 6 mg/cm², whereby a positive electrode for a lithium ion battery was obtained.

### Example 2

LiMn_{0.8}Fe_{0.2}PO₄ and LiMn_{0.3}Fe_{0.7}PO₄ were synthesized in the same way as in Example 1, except for the mixing ratio of metal sources. A positive electrode was manufactured in the same way as in Example 1, except that these were mixed at a weight ratio of 70:30.

### Example 3

LiMn_{0.8}Fe_{0.2}PO₄ and LiMn_{0.8}Co_{0.2}PO₄ were synthesized in the same way as in Example 1, except for the mixing ratio of metal sources. A positive electrode was manufactured in the same way as in Example 1, except that these were mixed at a weight ratio of 80:20.

### Example 4

LiFePO₄ and LiMn_{0.5}Fe_{0.5}PO₄ were synthesized in the same way as in Example 1, except for the mixing ratio of metal sources. A positive electrode was manufactured in the same way as in Example 1, except that these were mixed at a weight ratio of 80:20.

### Comparative Example 1

LiMn_{0.72}Fe_{0.25}CO_{0.03}PO₄ was synthesized in the same way as in Example 1, except for the mixing ratio of metal sources. A positive electrode was manufactured in the same way as in Example 1, except that only the active material synthesized with the above-mentioned composition was used.

### Comparative Example 2

LiMn_{0.65}Fe_{0.35}PO₄ was synthesized in the same way as in Example 1, except for the mixing ratio of metal sources. A positive electrode was manufactured in the same way as in Example 1, except that only the active material synthesized with the above-mentioned composition was used.

### Comparative Example 3

LiMn_{0.8}Fe_{0.1}Co_{0.1}PO₄ was synthesized in the same way as in Example 1, except for the mixing ratio of metal sources. A positive electrode was manufactured in the same way as in Example 1, except that only the active material synthesized with the above-mentioned composition was used.

### Comparative Example 4

LiMn_{0.1}Fe_{0.9}PO₄ was synthesized in the same way as in Example 1, except for the mixing ratio of metal sources. A positive electrode was manufactured in the same way as in Example 1, except that only the active material synthesized with the above-mentioned composition was used.

Table 1 shows positive-electrode active materials in the examples and the comparative examples and weight ratios thereof.

TABLE 1

| | | | | Weight ratio of |
|---|---|---|---|---|
| | Positive-electrode active material | | | Positive-electrode |
| | No. 1 | No. 2 | No. 3 | active material |
| Ex. 1 | LiMn_{0.8}Fe_{0.2}PO₄ | LiMn_{0.5}Fe_{0.5}PO₄ | LiMn_{0.8}Fe_{0.2}PO₄ | 60:25:15 |
| Ex. 2 | LiMn_{0.8}Fe_{0.2}PO₄ | LiMn_{0.3}Fe_{0.7}PO₄ | | 70:30 |
| Ex. 3 | LiMn_{0.8}Fe_{0.2}PO₄ | | LiMn_{0.8}Fe_{0.2}PO₄ | 80:20 |
| Ex. 4 | LiFePO₄ | LiMn_{0.5}Fe_{0.5}PO₄ | | 80:20 |
| Com. Ex. 1 | LiMn_{0.72}Fe_{0.25}Co_{0.03}PO₄ | | | |
| Com. Ex. 2 | LiMn_{0.65}Fe_{0.35}PO₄ | | | |
| Com. Ex. 3 | LiMn_{0.8}Fe_{0.1}Co_{0.1}PO₄ | | | |
| Com. Ex. 4 | LiMn_{0.1}Fe_{0.9}PO₄ | | | |

### Manufacturing of Battery

The manufactured positive electrode was dried at 80° C. for 1 hour, and then was punched in a disc shape with a diameter of 15 mm by the use of a punching tool. The resultant was compressed by the use of a hand-operated press. The total thickness of the positive electrode was set to 38 to 42 μm. All the electrodes were manufactured to satisfy the above-mentioned amount coated and the above-mentioned thickness, whereby the electrode structure was kept constant. The electrode was dried at 120° C. before assembling a model cell. In order to exclude the influence of moisture, all the operations were performed in a dry room.

Evaluation was made using a three-electrode model cell simply imitating a battery. A test electrode punched with φ15 mm, an aluminum collector, a counter-electrode metal lithium, and a reference-electrode metal lithium were stacked with a separator, in which an electrolyte (EC:MEC=1:2, 1M LiPF₆) was impregnated, interposed therebetween. The stacked body was interposed between two SUS end plates and the resultant was fastened with bolts. The resultant was put into a glass cell and was used as a three-electrode model cell. The test was performed in a glove box in the argon atmosphere.

First, initialization was performed.

In the initialization, the model cell was charged with a constant current of 1 mA to 4.5 V, and was charged with a constant voltage until the current value was lowered to 0.05 mA after reaching 4.5 V. In the discharging, the model cell was discharged up to 2 V with a constant current of 0.1 mA. This cycle was repeated three times to perform the initialization.

In evaluation of an open circuit voltage curve (OCV curve), the model cell was charged to an amount of electricity corresponding to 2% of the capacity with a current of 0.1 mA after the model cell was fully discharged to 2 V. A value when the capacity per unit weight of the active material was set to 170 Ah/kg was used as the capacity. When the amount of electricity reached 2% of the capacity, the charging was stopped, the model cell was left in the open circuit for 3 hours, and the voltage variation at that time was recorded. The OCV when the model cell was left for 3 hours was set as a measuring point. Thereafter, the model cell was charged to 2% of the capacity with a current of 0.1 mA again.

This operation was repeated until the total amount of electricity charged exceeded 100%, whereby an OCV curve was obtained. The dV/dQ was calculated by dividing the difference in OCV between two neighboring points by the amount of electricity Q which flows therebetween.

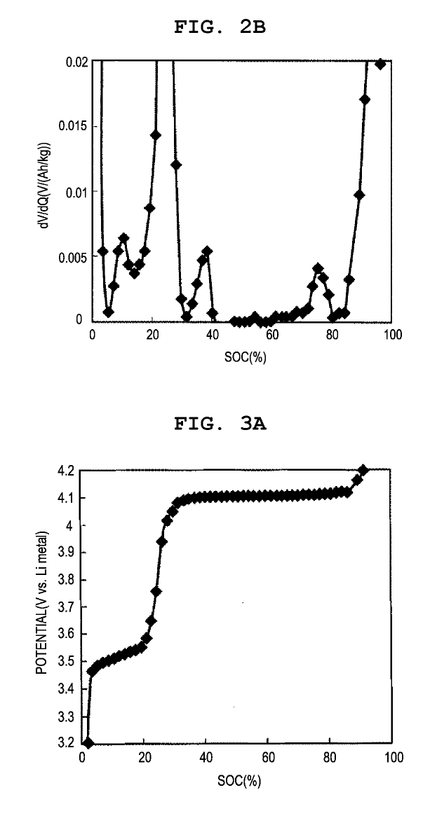

FIGS. 2A, 3A, 4A, 5A, 6A, 7A, 8A, and 9A show the OCV curves when the positive electrodes according to the examples and the comparative examples are used. The horizontal axis represents the SOC and the vertical axis represents the potential with respect to lithium metal.

FIGS. 2B, 3B, 4B, 5B, 6B, 7B, 8B, and 9B show the dV/dQ curves when the positive electrodes according to the examples and the comparative examples are used. The horizontal axis represents the SOC and the vertical axis represents dV/dQ.

FIGS. 2A and 2B show a case where the positive electrode according to Example 1 is used.

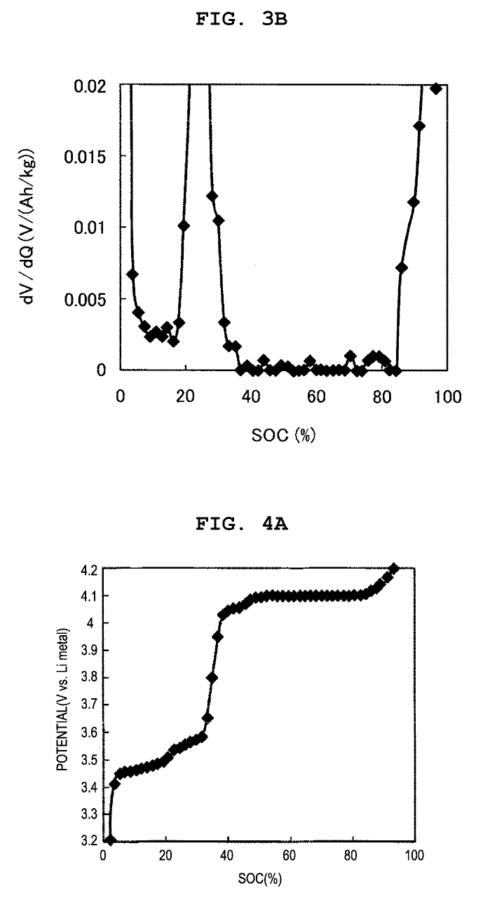

FIGS. 3A and 3B show a case where the positive electrode according to Comparative Example 1 is used.

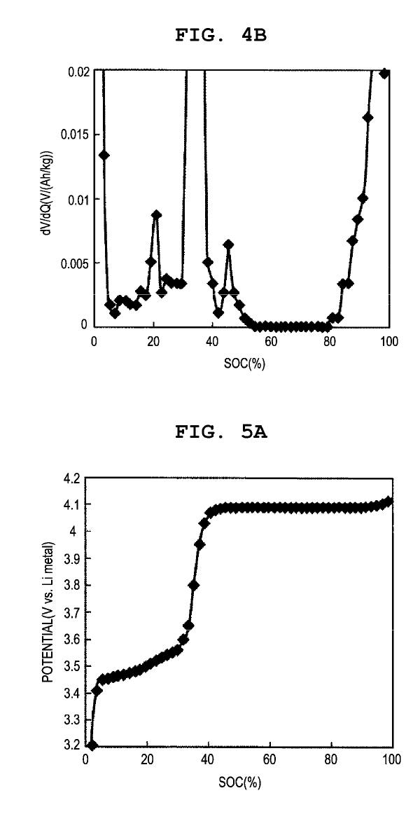

FIGS. 4A and 4B show a case where the positive electrode according to Example 2 is used.

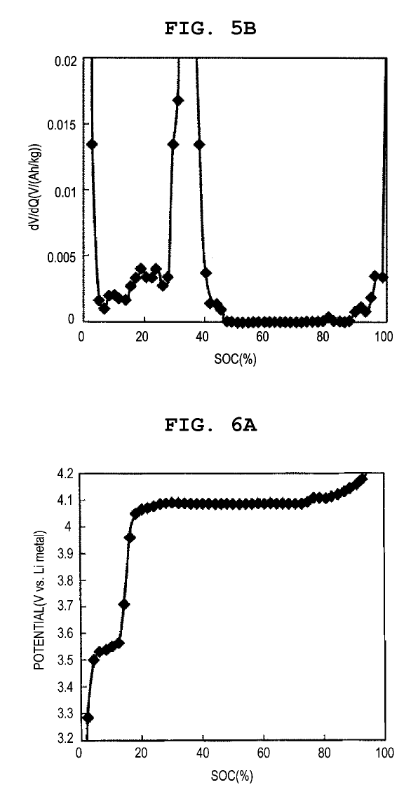

FIGS. 5A and 5B show a case where the positive electrode according to Comparative Example 2 is used.

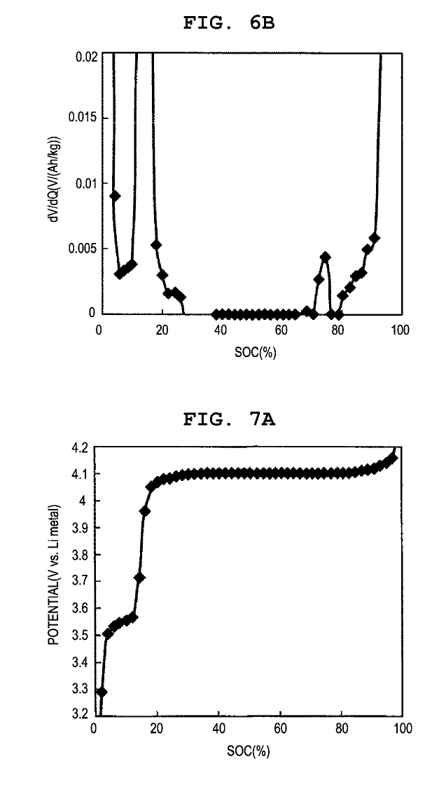

FIGS. 6A and 6B show a case where the positive electrode according to Example 3 is used.

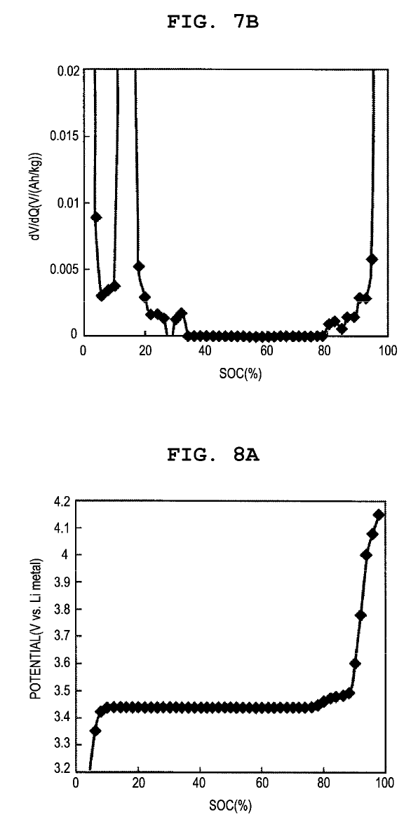

FIGS. 7A and 7B show a case where the positive electrode according to Comparative Example 3 is used.

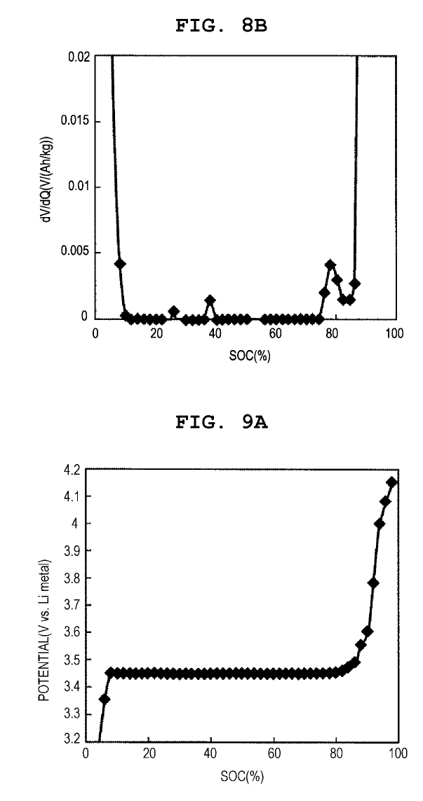

FIGS. 8A and 8B show a case where the positive electrode according to Example 4 is used.

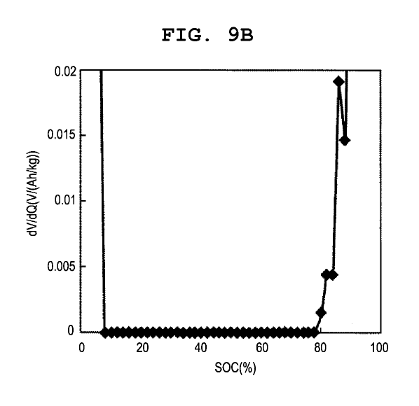

FIGS. 9A and 9B show a case where the positive electrode according to Comparative Example 4 is used.

Example 1 and Comparative Example 1 will be described first.

In Example 1 and Comparative Example 1, the composition ratio of Mn, Fe, and Co is constant over the whole positive electrode.

In FIG. 2A which shows the OCV curve of Example 1 in which plural positive-electrode active materials are mixed, four potential level differences are present. Three thereof are minute level differences in which the variation is equal to or less than 200 mV. In the dV/dQ curve of Example 1 shown in FIG. 2B, four peaks can be confirmed.

On the contrary, in FIG. 3A which shows the result of Comparative Example 1, only one large potential level difference is present and only one peak is present in the dV/dQ curve shown in FIG. 3B. Accordingly, in Comparative Example 1, it is difficult to detect the SOC, compared with Example 1.

As shown in FIGS. 2A, 2B, 3A, and 3B, when plural positive-electrode active materials are mixed, the number of potential level differences can be increased and it is possible to easily detect the SOC of the battery by detecting the potential level differences. Accordingly, it is possible to accurately control the battery and thus to achieve the elongation of the lifetime and the stable operation of the battery.

An initial rising region, a flat region, a detectable voltage varying region, and a terminal rising region in the region of the state of charge (SOC) of 0% to 100% will be described below with reference to the drawings.

In FIG. 2A, four potential level differences are present as described above. These potential level differences are the detectable voltage varying regions. In the drawing, the potential level differences are present around the SOCs of 10%, 23%, 38%, and 75%. Among these, the potential level difference around the SOC of 23% is a large potential level difference and the dV/dQ in FIG. 2B is equal to or greater than 0.02 V/(Ah/kg). At the potential level differences around the SOCs of 10%, 38%, and 75%, the dV/dQ in FIG. 2B is about 0.005 V/(Ah/kg).

In FIGS. 2A and 2B, the region in which the SOC is equal to or less than 5% is the initial rising region, and the region in which the SOC is equal to or greater than 88% is the terminal rising region. The regions in which the SOC is in the range of 5% to 7%, the range of 12% to 18%, the range of 28% to 33%, the range of 40% to 70%, and the range of 78% to 85% are the flat regions.

Example 2 and Comparative Example 2 will be described below.

In Example 2 and Comparative Example 2, the composition ratio of Mn and Fe is constant over the whole positive electrode.

In FIG. 4A which shows the OCV curve of Example 2 in which plural positive-electrode active materials are mixed, three potential level differences (detectable voltage varying regions) are present. Two thereof are minute level differences in which the variation is equal to or less than 200 mV. In the dV/dQ curve of Example 2 shown in FIG. 4B, three peaks can be confirmed.

That is, in FIGS. 4A and 4B, the detectable voltage varying region is present around the SOCs of 20%, 35%, and 45%. The region in which the SOC is equal to or less than 5% is the initial rising region, and the region in which the SOC is equal to or greater than 85% is the terminal rising region. The regions in which the SOC is in the range of 5% to 18%, the range of 22% to 35%, the range of 40% to 45%, and the range of 50% to 82% are the flat regions.

On the contrary, in FIG. 5A which shows the result of Comparative Example 2, only one large potential level difference is present and only one peak is present in the dV/dQ curve shown in FIG. 5B. Accordingly, in Comparative Example 2, it is difficult to detect the SOC, compared with Example 2.

As shown in FIGS. 4A, 4B, 5A, and 5B, it is possible to easily detect the SOC in Example 2, compared with Comparative Example 2.

Example 3 and Comparative Example 3 will be described below.

In Example 3 and Comparative Example 3, the composition ratio of Mn, Fe, and Co is constant over the whole positive electrode.

In FIG. 6A which shows the OCV curve of Example 3 in which plural positive-electrode active materials are mixed, two potential level differences are present. One thereof is a minute level difference in which the variation is equal to or less than 200 mV. In the dV/dQ curve of Example 3 shown in FIG. 6B, two peaks can be confirmed.

That is, in FIGS. 6A and 6B, the detectable voltage varying region is present around the SOCs of 15% and 75%. The region in which the SOC is equal to or less than 5% is the initial rising region, and the region in which the SOC is equal to or greater than 85% is the terminal rising region. The regions in which the SOC is in the range of 5% to 10%, the range of 28% to 75%, and the range of 80% to 85% are the flat regions.

On the contrary, in FIG. 7A which shows the result of Comparative Example 3, only one large potential level difference is present and only one peak is present in the dV/dQ curve. Accordingly, in Comparative Example 3, it is difficult to detect the SOC, compared with Example 3.

As shown in FIGS. 6A, 6B, 7A, and 7B, it is possible to easily detect the SOC of the battery in Example 3, compared with Comparative Example 3.

Example 4 and Comparative Example 4 will be described below.

In Example 4 and Comparative Example 4, the composition ratio of Mn and Fe is constant over the whole positive electrode.

In FIG. 8A which shows the OCV curve of Example 4 in which plural positive-electrode active materials are mixed, one potential level difference is present. This is a minute level difference in which the variation is equal to or less than 200 mV. In the dV/dQ curve of Example 4 shown in FIG. 8B, one peak can be confirmed.

That is, in FIGS. 8A and 8B, the detectable voltage varying region is present around the SOCs of 78%. The region in which the SOC is equal to or less than 7% is the initial rising region, and the region in which the SOC is equal to or greater than 88% is the terminal rising region. The regions in which the SOC is in the range of 10% to 75% and the range of 80% to 85% are the flat regions.

On the contrary, in FIG. 9A which shows the result of Comparative Example 4, no potential level difference is present except the terminal and no peak is present in the dV/dQ curve. Accordingly, in Comparative Example 4, it is difficult to detect the SOC, compared with Example 4.

As shown in FIGS. 8A, 8B, 9A, and 9B, it is possible to easily detect the SOC of the battery in Example 4, compared with Comparative Example 4.

In the above-mentioned examples, a positive electrode in which two or three types of positive-electrode active materials having different compositions are mixed was manufactured using the olivine positive-electrode active materials including two or three types of metal elements. However, when positive-electrode active materials including more types of metal elements and having more different compositions are mixed to manufacture a positive electrode, it is possible to provide more potential level differences.

1-8. (canceled)

9. A positive-electrode material for a lithium ion battery comprising two or more positive-electrode active materials which are expressed by a chemical formula LiMPO₄, where M includes one or more metal elements selected from the group consisting of Mn, Fe, Co, and Ni, and which have an olivine structure,
wherein the M in at least one of the positive-electrode active materials includes two or more metal elements, and
wherein an open circuit voltage curve in charging includes an initial rising region, one or more flat regions, one or more detectable voltage varying regions, and a terminal rising region in a state-of-charge region of 0% to 100%.

10. The positive-electrode material for a lithium ion battery according to claim 9, wherein the positive-electrode active materials have a structure of two of the positive-electrode active materials include a common metal element which is common to the positive-electrode active materials as any of the metal elements and have a difference in a ratio of the common metal element in the M.

11. The positive-electrode material for a lithium ion battery according to claim 10, wherein the difference is equal to or more than 0.3.

12. The positive-electrode material for a lithium ion battery according to claim 9, wherein the positive-electrode active materials have a structure of at least one of the positive-electrode active materials is a cobalt-containing positive-electrode active material including Mn and Co as the M, and at least one of the positive-electrode active materials is an iron-containing positive-electrode active material including Mn and Fe as the M.

13. The positive-electrode material for a lithium ion battery according to claim 12,
wherein the ratio of Co in the M in the cobalt-containing positive-electrode active material is in the range of 0.05 to 0.3, and
the ratio of Co in the M in the overall positive-electrode active materials expressed by LiMPO₄ is equal to or less than 0.1.

14. The positive-electrode material for a lithium ion battery according to claim 9,
wherein the voltage varying region is a region in which the potential varies by 20 mV or more and up to 200 mV when the state of charge varies by 3%.

15. A lithium ion battery comprising:
a positive electrode;
a negative electrode; and
a separator interposed between the positive electrode and the negative electrode,
wherein the positive electrode includes the positive-electrode material for a lithium ion battery according to claim 9.

16. The lithium ion battery according to claim 15, wherein the negative electrode includes a negative-electrode active material which is activated in a two-phase-coexistence charging-discharge reaction.

17. The lithium ion battery according to claim 16, wherein the negative-electrode active material is graphite or lithium titanate.

18. The lithium ion battery according to claim 15, wherein the positive-electrode active materials have a structure of two of the positive-electrode active materials include a common metal element which is common to the positive-electrode active materials as any of the metal elements and have a difference in a ratio of the common metal element in the M.

19. The lithium ion battery according to claim 18, wherein the difference is equal to or more than 0.3.

20. A method of controlling a lithium ion battery, comprising:
connecting a current measuring circuit and a voltage measuring circuit to the lithium ion battery according to claim 15;
calculating a derivative of a potential with respect to an amount of electrical storage of the lithium ion battery from the variations in current and voltage when the battery operates; and
detecting the state of charge from the derivative.
